(19) United States
(12) Patent Application Publication
(10) Pub. No.: US 2024/0351157 A1
(43) Pub. Date: Oct. 24, 2024

(54) Retainer for the Processing of Optical Workpieces, Particularly Spectacle Lenses

(71) Applicant: Satisloh AG, Baar (CH)

(72) Inventors: Holger Schäfer, Weilmunster (DE); Martin Lautz, Nauborn (DE); Johannes Claar, Ebsdorfergrund (DE); Janis Wortmann, Wessobrunn (DE)

(21) Appl. No.: 18/637,089

(22) Filed: Apr. 16, 2024

(30) Foreign Application Priority Data
Apr. 20, 2023 (DE) 10 2023 110 130.7

(51) Int. Cl. B24B 13/005; B23C 3/16

(52) U.S. Cl. CPC B24B 13/005; B23C 3/16

(57) ABSTRACT

A retainer for the processing of workpieces comprises a housing with a holding arrangement for a workpiece to be processed as well as a support arrangement therefor, which comprises a plurality of longitudinally displaceable pins accommodated in a chamber bounded by the housing. The pins are selectively fixable by a clamping mechanism with their pin ends for firmly supporting the workpiece. The clamping mechanism has at least one force transmission element which is movable with respect to the pins by forces able to be applied by fluid so as to selectively clamp the pins in an unactuated state of the retainer or free them in an actuated state of the retainer.

### TECHNICAL FIELD

The present invention relates generally to a retainer for the processing of optical workpieces. In particular, the invention relates to a retainer for the processing of spectacle lenses, preferably spectacle lenses of plastic such as, for example, polycarbonate, CR39 or so-called “high index” materials, but in principle also for spectacle lenses of hard brittle materials such as, for example, mineral glass. Spectacle lenses of that kind are produced on a large scale in so-called “RX workshops”, i.e. production facilities for production of individual spectacle lenses according to prescription.

The retainer described herein develops the retainer described in earlier German Patent Application DE 10 2021 005 202.1 (DE 10 2021 005 202 A1) of the same applicant and is very well suited for use in, for example, a method for (area) processing by machining of, in particular, spectacle lenses of plastic, such as described in the document DE 10 2021 004 831 A1. In addition, specific use can be made at the retainer described here of an elastic membrane such as is the subject of German Patent Application DE 10 2023 110 129.3, filed at the same time under the title “Elastic membrane for a retainer for the processing of optical workpieces, particularly spectacle lenses, and retainer equipped therewith”, of the same applicant. Express reference is made at this point to the afore-mentioned documents (DE 10 2021 005 202 A1, DE 10 2021 004 831 A1, DE 10 2023 110 129.3) with respect to further structural details of the mount or the elastic membrane as well as use and method details.

### PRIOR ART

In the above-mentioned document DE 10 2021 004 831 A1 there has already been detailed description of those process steps which currently are usually performed in RX workshops in the industrial production of spectacle lenses, so that the usual procedure need be only briefly outlined at this point. The starting product in industrial production of spectacle lenses is a semi-finished spectacle lens blank, also termed “blank”, which has one optically effective surface already processed to finished state and provided by injection molding or preshaped in some other way and which is to be processed at its other optically effective surface and at the edge between the optically effective surfaces to form a finished spectacle lens.

After protection of the preshaped optically effective surface by a protective film or a protective lacquer so-called “blocking” of the respective spectacle lens blank is carried out, which in that case is connected with a suitable so-called “block piece”, for example a block piece in accordance with German Standard DIN 58766. For the blocking, firstly position and optionally shape of the spectacle lens blank are determined by measurement before the spectacle lens blank is then positioned in six degrees of freedom relative to the block piece so that the block piece adopts a predetermined position relative to the protected, preshaped surface of the spectacle lens blank. Fixing of this set position takes place subsequently by filling the space between block piece and spectacle lens blank with a conventional molten material (“alloy” or wax; see, for example, EP 1 593 458 A2) or alternatively by a suitable thermoplastic, thermosetting or elastomeric plastic or adhesive (see, for example, DE 10 2007 007 161 A1, EP 2 011 604 A1, WO 2009/135689 A1). After solidifying or hardening of the filler material the block piece represents a mount or machine interface for processing of the spectacle lens blank, which subsequently remains at the spectacle lens for several processing procedures in different machines so as to then be able to rotationally drive the spectacle lens and reliably hold it in an always defined position.

In the next process step, i.e. the so-called “generation”, the hitherto not yet processed optically effective surface of the respective spectacle lens blank gains its macrogeometry, i.e. optically active shape in accordance with prescription, in a special processing machine, also called “generator” (see, for example, EP 1 719 585 A2, EP 2 011 603 A1), by (preliminary) processing by machining; in the case of plastic this is usually milling and/or turning with a geometrically defined cutting edge. In that case the blocked spectacle lens blank is held by the block piece at a rotationally driven workpiece spindle. The generation usually comprises at least two sub-steps (see, for example, EP 1 203 626 B1), namely preliminary edge processing, also called preliminary edging or “cribbing”, in which the edge of the spectacle lens blank is processed from the so-called “raw diameter” to the so-called “finished diameter”—in the case of plastic by, for example, a plate mill (cf., for example, EP 0 758 571 B1)—and a surface processing subsequent thereto. In the case of plastic the latter can begin by a (at least one) milling cycle over the surface, in accordance with which the main quantity of the blank material to be removed is already taken away, usually followed by an “out-of-round” rotary processing with the help of a so-called “fast tool” arrangement (see, for example, EP 1 779 967 A2) for the reciprocating drive of a diamond turning tool so as to (also) work non-rotationally symmetrical surface sections—for example freeform areas in varifocal lenses—at the semi-finished product. A precondition for the discussed preliminary edge processing by a mill is that the block piece temporarily mounted on the front side of the spectacle lens blank has a maximum diameter smaller than the finished diameter of the workpiece, since otherwise a collision between milling tool and block piece would occur.

Fine processing by (micro) machining, which is broadly termed “polishing”, of the spectacle lenses is then carried out, in which the pre-processed optically effective surface of the respective semi-finished product gains the desired microgeometry (surface quality), in particular by geometrically undefined cutting. For that purpose the blocked semi-finished product, which has been pre-processed by machining, is removed from the generator and further processed in a fine-processing or polishing machine (see, for example, EP 2 308 644 A2). In that case, positioning and fixing of the semi-finished product in the polishing machine also take place by the block piece (see, for example, EP 1 473 116 A1). During the polishing treatment there is movement—with addition of a liquid polishing agent provided with abrasive particles—by a flexible polishing tool or polishing plate (see, for example, EP 1 698 432 A2, WO 2016/058661 A1) in defined tracks over the pre-processed surface so as to reduce surface roughness.

Marking of the semi-finished product takes place as a next, optional process step, wherein, for example, two small circles are generated on the rear surface of the semi-finished product by, for example, a laser beam or mechanically by an engraving graver (see, for example, EP 1 916 060 B1). This is necessary for, for example, freeform surfaces so as to reliably find, by way of the applied markings, the position of the semi-finished product in later processing steps. Since a high degree of accuracy in positioning is required here, positioning and fixing during marking also take place by way of the block piece.

The semi-finished product is separated from the block piece only after this processing. The so-called “deblocking” takes place, for example, in the case of the afore-mentioned adhesive connection by a high-pressure water jet which is delivered by a nozzle and which impinges on an edge location between block piece and semi-finished product in order to detach the semi-finished product from the block piece by application of hydraulic forces (see, for example, WO 2011/042091 A1, WO 2011/107227 A1). As a consequence, the processed semi-finished product is now present as a single item and the separated block piece is cleaned and returned to the process step of blocking.

In further processing, the semi-finished product after cleaning is optionally coated at its front side and/or rear side in order to achieve additional effects: increase in scratch resistance by hard-coating, anti-reflection properties, coloration, metallization, hydrophobic properties, etc.

In conclusion, so-called “edging” is performed as a final process step, in which the semi-finished product is processed again at the edge for fitting into a desired spectacles frame, so that it receives the shape of the respective spectacles rim. Since the semi-finished product is now no longer fixed on the block piece, the position has to be re-established here (for example by way of the afore-mentioned markings) before the semi-finished product can be suitably fixed and finally processed in a so-called “edger” as an edge processing device (see, for example, EP 1 243 380 A2) with respect to its edge shape and fastening in the spectacles frame.

The process chain outlined in that regard from the prior art includes in the steps “blocking” and “deblocking” two sequences which represent necessary auxiliary processes, but do not themselves enhance the value of the produced spectacle lens. A process chain managing without these auxiliary processes would thus be desirable. In particular, in order to increase efficiency and also for ecological considerations it has already been proposed in the prior art to operate “blocklessly” in the production of optically effective surfaces of spectacle lenses, wherein the spectacle lenses are held by special holding devices or retainers during the processing (see, for example, documents WO 2015/059007 A1, U.S. Pat. No. 9,969,051 B2, DE 10 2016 112 999 A1 and DE 10 2004 016 445 B4).

As discussed in detail in earlier German Patent Application DE 10 2021 005 202.1 (DE 10 2021 005 202 A1) already mentioned in the introductory portion of the description, to which at this point reference may again be made, in the previously known holding devices or retainers there is, however, the risk that the spectacle lenses in or during processing experience undesired elastic deformations or deflections, whether in consequence of unsupported cavities under the respective lens, into which the lens is deformed under the acting processing forces (WO 2015/059007 A1, U.S. Pat. No. 9,969,051 B2) or due to mechanical clamping at the circumferential edge of the respective lens by radially directed clamping forces (DE 10 2016 112 999 A1, DE 10 2004 016 445 B4). In the case of processing comparatively thin lenses this can lead to, in particular, unacceptable differences between the actual geometry produced at the rear surface and the target geometry desired thereat, which become noticeable when the lens after processing “relaxes” again. Such lens deformations detracting from processing quality and caused by the retention system are particularly critical when comparatively complex surface geometries, i.e. other than purely spherical or toroidal surfaces, are to be produced.

In order to hold and support the workpiece during workpiece processing in a manner more reliable in terms of process and without workpiece deformations detracting from processing quality a special retainer for the processing of optical workpieces, particularly spectacle lenses, each with two workpiece surfaces and a workpiece edge therebetween is proposed in earlier German Patent Application DE 10 2021 005 202.1 (DE 10 2021 005 202 A1). This retainer comprises a holding arrangement for a workpiece to be processed as well as a support arrangement for the workpiece to be processed. In the embodiment disclosed here the support arrangement has a rubber-elastic membrane mounted on a housing and having a retaining section, on the outer side of which the workpiece can be laid over an area by one of its workpiece surfaces. The membrane together with the housing bounds a chamber in which a plurality of separate longitudinally displaceable pins of the support arrangement is accommodated, each of which pins can be brought by a pin end into contact with an inner side of the retaining section of the rubber-elastic membrane. In addition, these pins are selectively fixable to one another by a transversely acting clamping mechanism against longitudinal displacement with respect to the housing or can be blocked by an axially acting blocking mechanism, in order to firmly support the retaining section in accordance with a geometry of the workpiece held by the holding arrangement. Moreover, a special feature of the retainer in the embodiment disclosed therein is that the holding arrangement for the workpiece to be processed is provided in or at the retaining section of the rubber-elastic membrane and is capable of holding the workpiece without engaging the workpiece edge.

In this solution the clamping mechanism comprises at least one force transmission element by way of which a clamping force is transmissible to the pins, the force running from a side of the housing substantially in the direction of a center axis of the housing and acting perpendicularly to the longitudinal axes of the pins. In that case, the force transmission element can be mechanically loaded with the clamping force by way of at least one set screw mounted on the housing. Also mentioned as an alternative are, for example, pneumatic, hydraulic or electrical actuators for automated loading of the pins with transverse force, but without further details with respect thereto being disclosed.

What is desired is to provide, particularly for a production process chain ideally managing entirely without blocking, a retainer for the processing of optical workpieces, in particular spectacle lenses, which generally addresses the problems described above with respect to the prior art and is especially capable of holding and supporting a workpiece during workpiece processing in a manner which is more reliable in terms of process and without workpiece deformations detracting from processing quality and which is particularly suitable for use in an at least partly automated production environment.

### ILLUSTRATION OF THE INVENTION

According to one aspect of the invention, a retainer for the processing of optical workpieces, particularly spectacle lenses, which each have two workpiece surfaces and a workpiece edge therebetween, comprises a housing with a holding arrangement for a workpiece to be processed as well as a support arrangement therefor, which comprises a plurality of pins accommodated in a chamber bounded by the housing, which least for the major part are separately displaceable and which are selectively fixable—preferably to one another—by a clamping mechanism against longitudinal displacement with respect to the housing and by the pin ends thereof serve the purpose of supporting firmly the workpiece, which is held by one of its workpiece surfaces at the retainer by way of the holding arrangement, over an area at the workpiece surface facing the pin ends in accordance with the geometry of the surface, wherein the clamping mechanism has at least one force transmission element which is movable with respect to the pins by forces able to be applied by fluid so as to selectively clamp the pins in an unactuated state of the retainer or free them in an actuated state of the retainer.

The retainer according to one aspect of the invention combines different functions significant for high-quality processing of areal workpieces. Areal workpieces such as, for example, spectacle lenses, are distinguished by the fact that they have significantly larger dimensions in width direction and length direction than in thickness direction. This workpiece geometry in the case of processing by machining has the consequence that the workpiece itself particularly in the case of separating forces engaging near the edge of the workpiece and directed away from the workpiece forms a comparatively large lever arm which involves a risk of the workpiece being “levered off” its mount during the machining. At the same time, the comparatively small thickness of the workpiece specifically creates a rather small moment of resistance to bending, with the risk of an (at least) elastic deformation under the respectively prevailing processing forces. The requirements resulting therefrom for a workpiece retainer which functions reliably and is conducive to high processing quality, namely on the one hand reliably holding the areal workpiece during processing and on the other hand sufficiently supporting or propping up against undesired deformations, and that in at least partly automated production environment, are addressed in special manner by the retainer according to the invention with the holding and supporting arrangements thereof.

In that regard, at the outset the configuration of the support arrangement in accordance with the invention with a plurality of pins which for at least the major part are individually longitudinally displaceable and the pin ends of which are capable of firmly supporting over an area the workpiece—which is held by one of its workpiece surfaces at the retainer by way of the holding arrangement—at the workpiece surface facing the pin ends, advantageously enables very accurate “forming” to the surface, which is laid on the retainer, of the workpiece to be retained before the pins are clamped by the clamping mechanism so as to provide a fixed or rigid support surface for the workpiece. Thus, according to one aspect of the invention there are no larger cavities, into which the workpiece retained at the retainer could “deflect in” during the processing, present under the workpiece.

The sub-feature according to which the pins are separately longitudinally displaceable “at least for the major part” in this connection signifies that basically all pins can indeed be individually longitudinally displaceable, but do not have to be. Rather, there shall be no exclusion from protection of embodiments of the retainer in which, for example, three pins are arranged to not be longitudinally displaceable at all or arranged not to be longitudinally displaceable to full extent, so as to possibly form in this example a “three point support” which can make manual or automatic loading of the retainer with the optical workpiece simpler. The said three pins can then also have only a very small axial play of, for example, 0.1 millimeters and be clamped in common with all other pins. Moreover, in order to, especially, increase support area these three (quasi) stationary pins also have at the ends thereof facing the workpiece a larger diameter than the remaining pins of the pin packet. However, with respect to greatest possible universal suitability of the retainer for any workpiece geometries or curvatures—within the scope of a predetermined maximum workpiece diameter—it is preferred if all pins of the support arrangement are arranged to be longitudinally displaceable in the unclamped state.

Due to the fact that the forces for movement of the at least one force transmission element of the clamping mechanism relative to the pins, so as to either clamp or free the pins as desired, can be applied by a fluid this movement can in addition be “remotely controlled” in simple manner. Thus, the fluid can be conducted to the location of the activity by way of, for example, suitable passages or channels in the retainer and/or a workpiece spindle carrying the retainer, by contrast with the solution which is explicitly disclosed in earlier German Patent Application DE 10 2021 005 202.1 (DE 10 2021 005 202 A1) and in which the force transmission element can be mechanically loaded with the clamping force by way of at least one set screw mounted on the housing of the retainer, which requires mechanical engagement or access laterally of the retainer into the work space of the processing machine in or at which the retainer is used.

In that regard the forces, which can be applied by fluid, for the at least one force transmission element basically serve the purpose of clamping the pins—which is described in more detail in the following in a preferred embodiment—or, however, freeing the pins. An embodiment of the clamping mechanism is conceivable for the latter case in which, for example, the at least one force transmission element in order to clamp the pins is loaded by a spring mechanism by a force in the direction of the pins which, in order to free the pins, can oppose a force applied by fluid.

According to one aspect of the invention, regardless of the effective direction of the forces, which are able to be applied by fluid, it is provided in every case with respect to the operating state of the pins, i.e. “clamped” or “freed”, that the pins are selectively clamped in the unactuated state of the retainer, i.e. passively, by the at least one force transmission element of the clamping mechanism or, however, freed in the actuated state of the retainer, i.e. actively, by the at least one force transmission element of the clamping mechanism. On the one hand this is advantageous with respect to process reliability, because, for example, during processing of an optical workpiece held on the retainer a failure or an omission of the possibility of actuating the retainer, i.e. changing the operating state of the clamping mechanism, would not have the consequence that the workpiece suddenly no longer experiences sufficient support during the processing. On the other hand, this is advantageous with respect to energy efficiency because no external energy feed is needed during use of the retainer to maintain the clamped state of the pins.

In summary, the features of (a) force application by fluid for actuation of the clamping mechanism and (b) passive clamping and active cancellation of clamping of the pins in accordance with one aspect of the invention tailor the proposed retainer to use in an at least partly automated production environment in, for example, block-free processing of spectacle lenses, such as described in, for example, document DE 10 2021 004 831 A1, to which at this point express reference may again be made with regard to process details.

In a preferred embodiment of the retainer a hydraulically loadable actuator is associated with the at least one force transmission element in order to selectively generate a transverse movement of the force transmission element with respect to the pins. Alternatively thereto, at the outset a pneumatically loadable actuator is, in fact, also conceivable. However, on the other hand particularly with respect to high energy density, most feasible direct force translation, smallest possible effective areas and a compact mode of construction a hydraulic system is preferred, the incompressible hydraulic fluid of which also does not have “resilient” yielding as in the case of air.

Further, as far as the movement direction of the force transmission element with respect to the pins is concerned, a longitudinal movement of the force transmission element in relation to the pins would, in principle, also be possible, for example by a clamping mechanism in which a wedge or several wedges is or are driven in axial direction of the pins into the center of the pin packet between the pins, similarly to the wedge solution disclosed in document WO 2009/135689 A1 (FIGS. 7 and 8). However, in the case of the here-preferred transverse movement of the force transmission element with respect to the pins, whole-area support of the optical workpiece retained at the retainer is simpler to achieve.

In an embodiment of the retainer preferred particularly with respect to smallest possible constructional outlay and need for installation space the at least one force transmission element can be deflectable by hydraulic loading of the actuator relative to the housing of the retainer against a resilient restoring force so as to clamp the pins. The resilient restoring force at the force transmission element in that case advantageously ensures that a certain degree of freeing of the pins occurs without hydraulic loading of the actuator, which is conducive to easiest possible axial displaceability of the individual pins. However, in the alternative the clamping force can also be applied by springs and released or cancelled by hydraulic loading of a suitably arranged actuator, as already indicated further above, this, however, being less preferred.

Fundamentally it is possible to construct the hydraulically loadable actuator in the manner of a hydraulic expansion chuck with a chamber arrangement surrounding the pins, for example in the form of an annular chamber with a circularly annular or polygonal ring-shaped cross-section, which is loadable with the hydraulic fluid, and an elastically deformable wall which bounds the chamber arrangement with hydraulic sealing relative to the pins and acts on the—or acts as a—force transmission element, which selectively clamps the pins, namely in the case of hydraulic loading of the chamber arrangement, or, however, frees them, particularly in the case of hydraulic relief of the chamber arrangement. On the other hand, however, with respect to lowest possible costs an embodiment of the retainer is preferred in which the hydraulically loadable actuator is formed by a piston-cylinder arrangement with a cylinder housing and at least one piston. By comparison with a hydraulic expansion chuck such a piston-cylinder arrangement advantageously also offers greater adjustment travels so that the individual pins can be more readily set free or more reliably freed.

In that case, the arrangement can in principle be such that the cylinder housing of the piston-cylinder arrangement is mounted on the housing of the retainer so that the at least one piston accommodated in the cylinder housing is movable with respect to the housing of the retainer. However, on the other hand particularly with respect to a smallest possible need for installation space an embodiment of the retainer is preferred in which the at least one piston of the piston-cylinder arrangement is secured to the housing of the retainer so that the cylinder housing of the piston-cylinder arrangement is movable relative to the housing of the retainer. Advantageously, the larger part of the piston-cylinder arrangement is thus moved, which offers a wider force introduction area for the force transmission element or as a force transmission element. Further components for force transmission, which is wide as possible or over greatest possible area, to the pins may thus be superfluous.

In that case for preference the at least one piston of the piston-cylinder arrangement is provided with a passage for hydraulic loading of the piston-cylinder arrangement. With advantage, then only one transition, which is to be sealed, of the hydraulic path from the housing of the retainer to the piston is required. However, in the alternative such a passage can also be formed at the cylinder housing, but that then would require a separate, in particular flexible, feed line with sealing at both ends and accordingly is less preferred.

It is in addition preferred if the cylinder housing of the piston-cylinder arrangement has two cylinder chambers in each of which a respective piston sealed at the circumference is received. By comparison with an equally conceivable variant with only one cylinder chamber with an associated piston, better guidance between the piston and the cylinder housing, in particular, then advantageously results. Moreover, a largest possible hydraulically effective surface can thus be achieved in simple manner with a comparatively small need for installation space. However, the latter is also accompanied by a cross-sectional shape of the piston and the associated pressure chamber in the cylinder housing departing from a circular cross-section, for example an oval or substantially rectangular cross-sectional shape, which would be more costly to produce and more difficult to seal relative to one another.

In a particularly preferred embodiment of the retainer the cylinder housing of the piston-cylinder arrangement is mounted on the housing of the retainer by way of at least one solid-body joint, which comprises a double arm in the manner of a parallelogram guide, to be resiliently deflectable. In that case, the solid-body joint has quasi a double function; on the one hand it ensures, specifically return in simple manner of the cylinder housing from a position deflected relative to the housing of the retainer and on the other hand it forms a fixed, although resilient, connection with the housing of the retainer. Guidance of the cylinder housing relative to the housing of the retainer would also be possible as an alternative to such a solid-body joint, but this is constructionally more costly and accordingly less preferred. A further advantage of the solid-body joint relative to a guide of the cylinder housing with respect to the housing of the retainer is that the solid-body joint prevents tilting and an accompanying heavy motion in the case of movement of the cylinder housing relative to the housing of the retainer.

Moreover, with regard to a smallest possible need for installation space and an embodiment with fewest possible components it is further preferred if the force transmission element is an integral component of the cylinder housing. Alternatively, the force transmission element can obviously also be constructed as a separate part, for example by a key, analogously to earlier German Patent Application DE 10 2021 005 202.1 (DE 10 2021 005 202 A1), even if here this is less preferred due to additional cost.

Furthermore, the force transmission element preferably has a planar contact surface for the pins and projects by the pins from the cylinder housing into the chamber. In principle, it is indeed also possible for the force transmission element to have a contact surface for the pins which, for example, has hollow-cylindrical curvature with respect to the pins about an axis parallel to the pin axes. However, on the other hand a planar contact surface has the advantage that simultaneous, parallel introduction of force to several pins is possible, so that the introduced forces can be utilized in the best possible way, namely substantially without generation of transverse force components at the pins as a reaction, which would in part mutually cancel as would be the case, for example, with a contact surface of hollow-cylindrical curvature in the above sense.

Moreover, as far as generation of the hydraulic pressure for the hydraulically loadable actuator associated with the force transmission element is concerned, the actuator in unactuated state of the retainer is preferably loaded with pressure by way of a pressure store, which in the actuated state of the retainer is relieved of pressure. In principle, use could in fact also be made of, for example, a hydraulic pump for pressure generation, but by comparison with a pressure store this is less preferred with respect to energy efficiency, fail-safety and process reliability.

In that case the pressure store can in principle be arranged outside the housing of the retainer. On the other hand, however, an embodiment of the retainer is preferred in which the pressure store is integrated in the housing of the retainer. This offers, in particular, the advantages that a pressure passage from the outside does not have to be provided, very short hydraulic paths are given and also there are only very small elasticities in the hydraulic system of the retainer.

As far as a concrete embodiment of such a pressure store for the hydraulic system of the retainer is concerned, this can be configured as, for example, a gas pressure store. However, on the other hand a construction of the retainer is preferred, particularly with respect to efficient utilization of installation space and low maintenance outlay, in which the pressure store comprises a piston-cylinder arrangement with a cylinder chamber and a piston which is spring-biased by way of a spring mechanism into the cylinder chamber for pressure generation and which is mechanically displaceable against the spring bias in the cylinder chamber for pressure relief. Such a spring store as mechanism for pressure generation by way of a piston-cylinder arrangement can advantageously be realized in simple manner with high energy density and high spring stiffness.

The spring mechanism for spring-biasing of the piston of the pressure store can thus preferably comprise plate springs arranged in a row. Advantages of such plate springs by comparison with, for example, helical compression springs—which fundamentally would also be usable for this purpose—are especially that as a consequence of high spring stiffness it is possible to realize large spring forces with a small spring stroke, thus a small need for axial installation space.

In principle, the spring mechanism can be mounted with a fixed spring stroke or bias travel on or in the pressure store in order to produce the spring bias. However, it is preferred, particularly with regard to compensation for tolerances at or in the components used for the spring mechanism, if the spring bias of the piston of the pressure store is settable at the spring mechanism. It is thus advantageously also possible to create different defined clamping force specifications in correspondence with the respective clamping requirements or to re-adjust the spring force according to need.

In order to set the spring bias of the piston the pressure store preferably comprises a setting mechanism by way of which a spring travel is steplessly presettable at the spring mechanism, such as, for example, a threaded drive. However, a stepped (only) adjustment possibility, for example with use of shims below, above or between individual springs of the spring mechanism for setting of the spring travel and thus of the spring bias, is equally conceivable, although less preferred.

Finally, in a preferred development of the retainer the pressure store can also have a settable abutment for the piston of its piston-cylinder arrangement, which limits mechanical displacement of the piston against the spring mechanism relative to the housing of the retainer. It is thus possible in simple manner to prevent the springs from deflecting in as a block, which advantageously extends the service life of the springs and protects them from overloading or spring breakage.

As already implied further above by the expression “at least one force transmission element” it is basically sufficient if the clamping mechanism comprises only one force transmission element for clamping the pins, assuming the pins can sufficiently support themselves against one another or relative to the housing. However, on the other hand it is preferred if the clamping mechanism comprises a plurality of force transmission elements which surround the pins in the chamber in a symmetrical arrangement and with each of which a respective hydraulically loadable actuator is associated. The advantages of such an arrangement by comparison with a clamping mechanism with only one force transmission element are, in particular, that each individual force transmission element has to cover only a comparatively small path in order to clamp the pins and the retainer is already better balanced overall as a consequence of the symmetry of the arrangement.

If the clamping mechanism comprises a plurality of hydraulically loadable actuators these can in principle each be hydraulically loaded by way of an individually associated pressure generating device. On the other hand, however, it is preferred particularly with respect to a smallest possible constructional outlay if the different actuators hydraulically communicate with one another so that the actuators can be hydraulically loaded in common. The same pressure can then act at all actuators, from which also advantageously results a “self-centering” effect at the or around the pin packet, wherein same deflection at each of the actuators additionally reduces the risk of imbalance.

In a further preferred embodiment of the retainer the support arrangement has a rubber-elastic membrane which is mounted on the housing of the retainer and together with the housing bounds the chamber and which has a retaining section, on the outer side of which the workpiece can be placed over an area by one of its workpiece surfaces. In that case, a perforation as a component of the holding arrangement of the retainer is preferably formed in the retaining section of the rubber-elastic membrane so that a vacuum applied to the chamber is present by way of the perforation on the outer side of the retaining section of the rubber-elastic membrane in order to hold a workpiece to be processed. Other operating principles for the holding arrangement are, however, also possible, as already described in detail in earlier German Patent Application DE 10 2021 005 202.1 (DE 10 2021 005 202 A1), to which at this point express reference may again be made with respect thereto.

A particular advantage of the claimed holding arrangement having the operating principle of “vacuum” is that the holding forces are simple to control not only with respect to the presence or non-presence thereof (i.e. holding force “on” or “off”) in the process, but also in their level, so that the workpiece can be held with greater or lesser strength—for example in dependence on its geometry and/or its material and the properties thereof and/or on the progress of processing and/or on the respectively acting processing forces—at the retaining section of the rubber-elastic membrane. Finally, satisfactory and easy controllability of the holding forces at the retainer is also conducive to a high level of process reliability.

Instead of a such a membrane it is certainly also possible to provide an annular seal at the housing of the retainer which in operation bears against the workpiece and separates an evacuable region of the chamber with the pins from the ambient atmosphere so as to form a kind of “suction cup” or “suction bell” as a component of the holding arrangement for the workpiece. However, by comparison with such an annular seal the afore-mentioned membrane offers the advantage, in particular, that the workpiece on the retainer is protected at its retained workpiece surface without great effort, namely by the retaining section of the membrane, whereas an annular seal would require special protective measures at the retained workpiece surface and/or the pin ends, for example in the form of a rubber ring or the like thereat, so as to reliably avoid damage to the held workpiece thus supported. The use of a rubber-like material in the contact region with respect to the workpiece additionally serves the purpose in every case of also being able to accept possible transverse forces or torsional moments during processing of the workpiece as a consequence of a comparatively high coefficient of friction without transverse displacement or twisting of the workpiece on the retainer occurring.

Moreover, as far as the support arrangement of the retainer with its pins suitably “packed” in the chamber of the housing and longitudinally displaceable at least for the major part is concerned these can fundamentally be arranged in the chamber to be freely longitudinally movable when the clamping by the clamping mechanism is removed and they are to that extent longitudinally displaceable. Adaptation or forming to the geometry of the workpiece to be held can then take place under external forces in that, for example, the retainer is “laid” from above on a workpiece to be held. In the case of, for example, the above-described preferred embodiment of the retainer with a rubber-elastic membrane bounding the chamber the longitudinally displaceable pins freed by the clamping mechanism then bear under the effect of gravitational acceleration by their mass against the inner side of the retaining section of the rubber-elastic membrane and, as a consequence of the thus-acting gravitational force, urge the flexible retaining section by its outer side against the workpiece to be retained. If the retaining section of the rubber-elastic membrane then bears by its outer side over the whole area against the counter-surface of the workpiece to be held, the pins can be clamped to one another by the clamping mechanism so that the molded surface geometry is quasi “frozen” and the retainer is consequently capable of supporting the workpiece over an area and firmly. In principle, other external forces acting on the pins can also be used instead of gravitational force for the forming process, for example, a magnetic force acting on the pins via the workpiece.

However, by comparison with the afore-described gravitational force solution an embodiment of the retainer is preferred, especially with respect to directional independence during the forming process, in which the longitudinally displaceable pins of the support arrangement are spring-biased in a direction away from the housing of the retainer.

For spring-biasing of the longitudinally displaceable pins of the support arrangement it is, for example, possible to assign a helical compression spring to each of the pins so as to produce the spring-biasing in the direction away from the housing, as is, for example, shown in earlier German Patent Application DE 10 2021 005 202.1 (DE 10 2021 005 202 A1; see, in particular, FIGS. 9 and 11 thereof) and described. However, on the other hand it is preferred particularly with respect to smallest possible constructional outlay if the longitudinally displaceable pins of the support arrangement are spring-biased in a direction away from the housing of the retainer with the help of at least one pneumatic spring element. Further advantages of a pneumatic spring element include the variability of the pressing force, which can be easily set by pressure increase or decrease in the pneumatic spring element, as well as the comparatively small dependence on spring travel.

In a preferred embodiment, which is particularly maintenance-friendly, of the retainer the pneumatic spring element can have a rubber-elastic bellows section held, preferably detachably, at a rigid securing section, which in turn is detachably secured by way of a magnetic coupling to a part of the retainer fixed relative to the housing. This advantageously makes possible simple and rapid exchange of the pneumatic spring element in its entirety or of the bellows section of the pneumatic spring element, for example in the case of damage. Thus, a new bellows section can be premounted at a rigid securing section and the pneumatic spring element inserted without use of tools into the housing of the retainer—during an only short machine shutdown—after removal of the pin packet and the worn, i.e. to be exchanged, pneumatic spring element from the chamber.

In an advantageous embodiment of the retainer there can be additionally associated with the pneumatic spring element an annular part which protectively surrounds the rubber-elastic, substantially circularly discoid hollow bellows section of the pneumatic spring element at the outer circumference and radially outwardly limits deflection of the bellows section. Thus, on the one hand it is possible in simple manner to prevent the inflated pneumatic spring element from coming into contact with radially adjacent, possibly sharp-edged, components of the retainer and in that case possibly being damaged. On the other hand, the protective annular part advantageously enables economic construction of the bellows section of the pneumatic spring element from a homogenous, relatively “thin” rubber-elastic material—by contrast to an alternatively conceivable embodiment of the pneumatic spring element which is specially circumferentially reinforced at the bellows section—whereby the resilient characteristics of the pneumatic spring element are substantially the same at each point of the bellows section.

In principle it is possible to accommodate the pins in the chamber in a packed arrangement having an approximately circularly round or a polygonal cross-section. However, an embodiment of the retainer is preferred in which the pins of the support arrangement are arranged in the housing of the retainer in a substantially hexagonal package, for which purpose six force transmission elements bound a substantially hexagonal opening through which the pins extend. A maximum density of packing of the pins, which is especially of advantage for reliability of clamping of the pins by the clamping mechanism, results from the substantially six-sided arrangement as seen cross-section. Moreover, by virtue of this cross-sectional shape of the pin packet a circular form is satisfactorily approximated, which is advantageous for areally supported retention of circularly round workpieces such as, for example, spectacle lens blanks.

As far as the pins themselves are concerned, these can in principle have any desired, for example polygonal, cross-section. However, with respect to, in particular, simple and economic production of the pins—which are in any case present in a large number in the chamber of the retainer (for example approximately 400 pieces in an actual embodiment)—it is preferred if the longitudinally displaceable pins of the support arrangement are cylindrical pins each with an offset clamping region of greatest diameter for clamping by the clamping mechanism, wherein the pins linearly bear by the clamping regions thereof against one another and/or the clamping regions of the pins have an outer diameter of between 1.0 millimeter and 10.0 millimeters, preferably between 2.0 millimeters and 6.0 millimeters and particularly preferably between 2.5 millimeters and 5.0 millimeters. A further advantage of the cylindrical form of the pins is that the pins do not have to be guided to prevent turning about their longitudinal axes, but can automatically adopt a desired rotational setting. In tests performed by the inventors it has moreover proved that an outer diameter of the longitudinally displaceable pins in the claimed range represents a very good compromise between a highest possible “grid resolution” for area support of the workpiece on the one hand and still adequate easy motion during longitudinal displacement of the individual pins after removal of the clamping on the other hand.

In an expedient embodiment of the retainer it can further be provided that the longitudinally displaceable pins of the support arrangement extend by the pin ends thereof through at least one apertured limiting plate, which limits longitudinal movement of the pins in the housing of the retainer, in particular by formation of an abutment for the thickened (end) region of the pins. Thus, on the one hand securing of the longitudinally displaceable pins against loss in the case of, for example, repair of the retainer is ensured in simple manner and on the other hand this represents easily realizable protection for a rubber-elastic membrane—insofar as present—which covers the pins and which cannot be excessively deflected by the pin packet optionally spring-biased in the direction of the membrane, since due to the limiting plate the pins cannot be moved unhindered in this direction.

Moreover, an embodiment of the retainer is preferred in which the housing of the retainer has a securing section for exchangeable securing to a workpiece spindle or the like. This is not only of advantage with respect to service-friendliness and low machine outage times in the case of maintenance, but also enables use of the retainer in different ways: 1) The retainer can be fixedly installed in the respective processing machine, wherein the workpiece is secured to the retainer, subsequently processed and then detached from the retainer again. 2) The retainer with retained workpiece can be brought in a machine from one work station to another work station. Thus, for example, in spectacle lens production different working steps such as generating, polishing and marking can be performed in a combined machine at different positions. 3) The retainer with mounted workpiece can also be transported from one machine to the next machine and thus newly clamped quasi in the manner of a “reusable block piece” in each instance by way of a zero point clamping system.

Finally, in a constructionally simple embodiment the housing of the retainer can have interfaces for supply of the retainer with vacuum and compressed air by way of a workpiece spindle. However, in the alternative the housing of the retainer can also have “independent” interfaces for mechanical or fluid actuation, which are actuated or loaded independently of the workpiece spindle, this, however, being connected with greater constructional outlay and accordingly less preferred.

Further features, characteristics and advantages of the retainer according to the invention are evident to the person ordinarily skilled in the art from the following description of a preferred embodiment.

### BRIEF DESCRIPTION OF THE DRAWINGS

The invention is explained in more detail in the following by way of a preferred embodiment with reference to the accompanying, partly schematic drawings, in which:

FIG. 1 shows a perspective view of a workpiece spindle for, for example, a combined CNC milling/turning machine for surface processing of, in particular, spectacle lenses as optical workpieces, obliquely from above and front left, on which a retainer according to the invention for the processing of optical workpieces is mounted, in combination with a pneumatic circuit, which is “connected” with pneumatic connections of the workpiece spindle, for illustration of the supply of the retainer with compressed air and vacuum by way of the workpiece spindle;

FIG. 2 shows a perspective exploded illustration, which is to enlarged scale by comparison with FIG. 1, of the workpiece spindle according to FIG. 1 with the retainer according to the invention separated therefrom;

FIG. 3 shows a perspective view, which is again enlarged in scale by comparison with FIG. 2, of the workpiece spindle from obliquely above and front left from a different viewing angle, with a view of a central plunger of the workpiece spindle for mechanical actuation of a clamping mechanism of the retainer as well as of two connection surfaces for coupling of the workpiece spindle with a securing section of the retainer, wherein the connection surfaces are provided with interfaces for supply of the retainer with vacuum and compressed air as well as with threaded bores for fixing the securing section of the retainer to the workpiece spindle;

FIG. 4 shows a perspective view, which corresponds in scale with FIG. 3, of the retainer according to FIGS. 1 and 2 from obliquely behind and top right with a view of the securing section, which is formed to be complementary with the connection surfaces of the workpiece spindle, of the retainer as well as interfaces for supply of the retainer with vacuum and compressed air;

FIG. 5 shows a perspective view of the retainer according to FIGS. 1 and 2 from obliquely behind and top left for illustration of further details of the supply interfaces, which are provided in the region of the securing section, of the retainer;

FIG. 6 shows a rear view, which is again enlarged by comparison with the illustration in FIGS. 4 and 5, of the retainer according to FIGS. 1 and 2;

FIG. 7 shows a sectional view of the retainer according to FIGS. 1 and 2 in correspondence with the section line Vll-Vll in FIG. 6, wherein the section course is selected so that the section runs through two screw connections by which resiliently deflectable cylinder housings of piston-cylinder arrangements of the clamping mechanism for longitudinally displaceable pins of a support arrangement of the retainer are secured to a housing of the retainer by way of solid-body joints;

FIG. 8 shows a sectional view, which is enlarged by comparison with the scale of FIG. 7 and which is broken away to the right along the center axis, of the retainer according to FIGS. 1 and 2 in correspondence with the section line Vlll-Vlll in FIG. 6 or 13, wherein the section course is selected so that a hydraulic connection, which emanates from a central pressure store—here illustrated unfilled—of the retainer and which is marked by a dashed line, for supply of one of the cylinder housings of the clamping mechanism is evident;

FIG. 9 shows a sectional view, which corresponds with the scale of FIG. 8 and which is again broken away to the right along the center axis, of the retainer according to FIGS. 1 and 2 in correspondence with the section line 1X-1X in FIG. 6, wherein the section course is selected so that a hydraulic connection, which emanates from the pressure store and which is marked by a dashed line, for relief of the hydraulic system of the clamping mechanism is evident;

FIG. 10 shows a part sectional view, which corresponds with the scale of FIG. 8 and which is broken away along the center axis, of the retainer according to FIGS. 1 and 2 in correspondence with the section line X-X in FIG. 6, wherein the section course is selected so that a pneumatic connection, which is marked by a dashed line, for supply of a pneumatic spring element is evident, the element serving for the purpose of resiliently biasing the individual longitudinally displaceable pins of the support arrangement in a direction away from the housing of the retainer;

FIG. 11 shows a part sectional view, which is reduced in size by comparison with the scale of FIG. 8 and which is broken away to the left, of the retainer according to FIGS. 1 and 2 in correspondence with the section line Xl-Xl in FIG. 6, wherein the section course is selected so that a pneumatic connection, which is marked by a dashed line, for evacuation of a chamber, which receives the pins of the support arrangement and which is bounded by a rubber-elastic membrane with a perforation as a component of a holding arrangement, is apparent, by way of which perforation the chamber vacuum for holding a workpiece is present outwardly at the membrane as indicated;

FIG. 12 shows a sectional view of the retainer according to FIGS. 1 and 2 to the scale of FIG. 6 and in correspondence with the section line Xll-Xll in FIG. 11, wherein the section course is selected so that securing of the piston of the piston-cylinder arrangements of the clamping mechanism to the housing of the retainer is illustrated;

FIG. 13 shows a sectional view of the retainer according to FIGS. 1 and 2 to the scale of FIG. 6 and in correspondence with the section line Xlll-Xlll in FIG. 11, wherein the section course is selected so that the section runs centrally through passages which are formed in the pistons of the piston-cylinder arrangements of the clamping mechanism and which are hydraulically loadable by way of the piston-cylinder arrangements;

FIG. 14 shows a perspective view, which with respect to section course is sectioned in correspondence with FIG. 8 and which by comparison with the illustration of FIG. 8 is turned in the plane of the drawing through 90 degrees in counter-clockwise sense, of the retainer according to FIGS. 1 and 2 from obliquely above and front left, wherein the rubber-elastic membrane, the pins of the support arrangement and one of the cylinder housings (back left), in particular, were omitted so as to reveal a view of two pistons, which are fixedly screw-connected with the housing of the retainer, of the piston-cylinder arrangements of the clamping mechanism;

FIG. 15 shows a perspective view, which is sectioned in correspondence with FIG. 14 and rotated, of the retainer according to FIGS. 1 and 2 from obliquely above and front left at a somewhat steeper viewing angle compared with FIG. 14, wherein by comparison with the illustration in FIG. 14 a rubber-elastic bellows section of the pneumatic spring element, the two pistons at back left and a further one of the cylinder housings (back right) were omitted so as to illustrate further details of the hydraulic system of the clamping mechanism of the retainer;

FIG. 16 shows an enlarged back view of a cylinder housing, which is separated from the retainer according to FIGS. 1 and 2, of the clamping mechanism of the retainer, with a view into the two cylinder chambers of the cylinder housing;

FIG. 17 shows a perspective view of the cylinder housing according to FIG. 16 from obliquely above and back right, particularly for better illustration of the solid-body joints mounted on the cylinder housing at the bottom;

FIG. 18 shows a perspective view of the cylinder housing according to FIG. 16 from obliquely above and front left, with a view of a force transmission element formed integrally with the cylinder housing; and

FIG. 19 shows a perspective view of the cylinder housing according to FIG. 16 in correspondence with the section line XlX-XlX in FIG. 16 from obliquely above and back right, wherein a part of the concealed body edges of the cylinder housing is depicted by dashed lines, for illustration of a passage, which connects the cylinder chambers, between the cylinder chambers and of measures for relieving the cylinder chambers.

### DETAILED DESCRIPTION OF THE EMBODIMENT

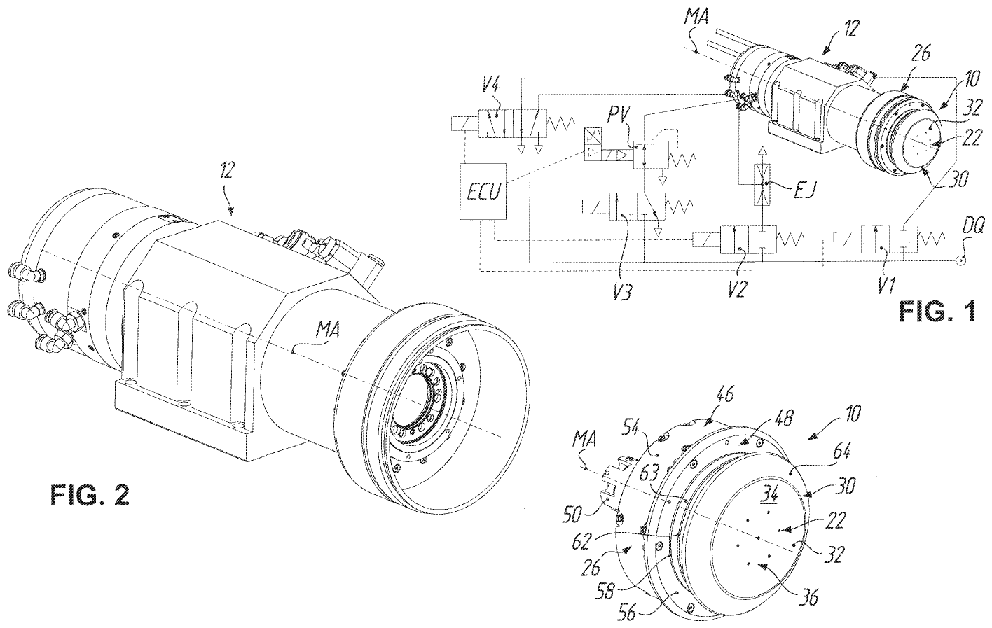

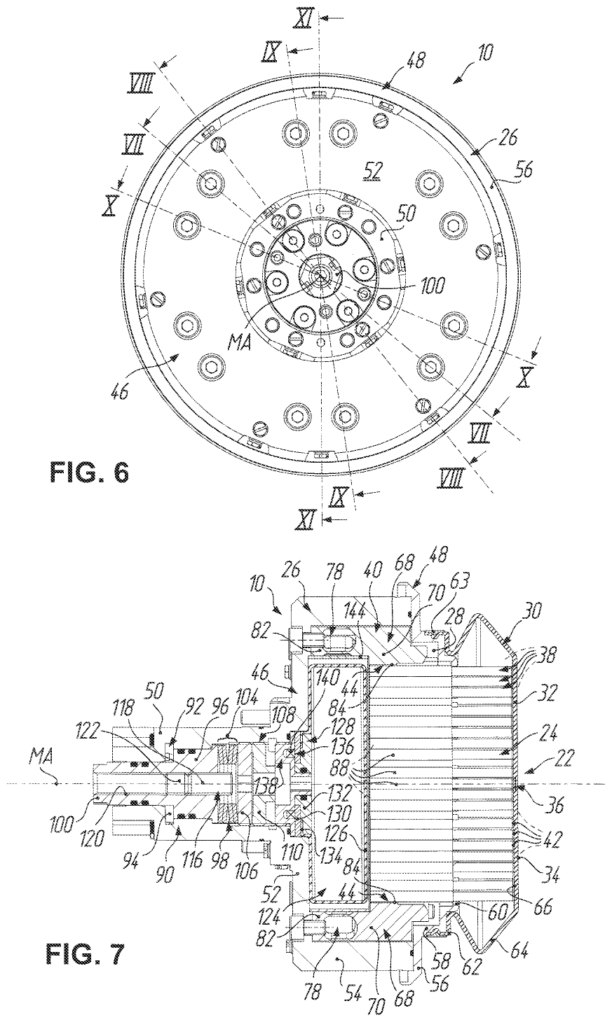

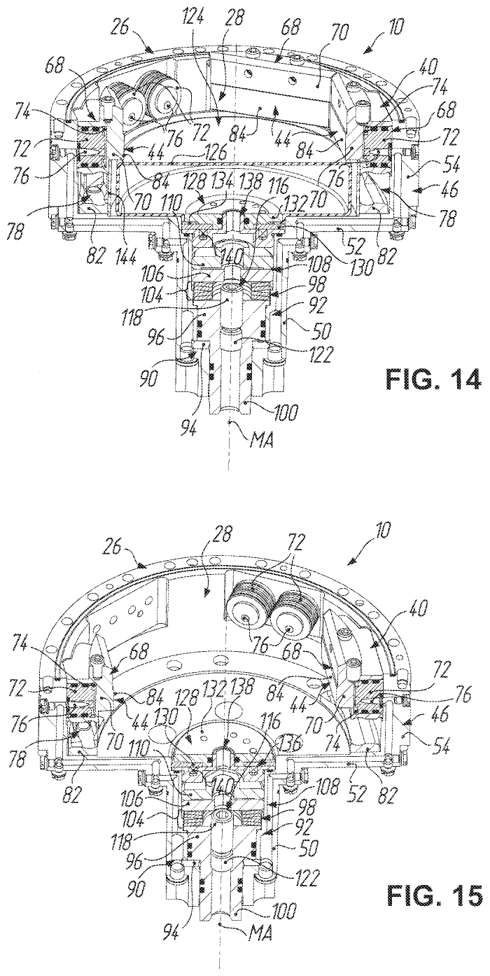

A workpiece spindle 12 is illustrated in FIGS. 1 to 3 by way of example for a technical environment in which use can be made of a workpiece retainer 10 described in detail by an embodiment in the following on the basis of FIGS. 4 to 19. Such a workpiece spindle 12 can for its part be used in, for example, a combined CNC milling/turning machine for processing of, in particular, spectacle lenses, also termed generator in this sector. Such generators are available from, for example, Satisloh AG, Baar, Switzerland, under the commercial designation “VFT-orbit” and are the subject of document EP 2 011 603 A1, to which at this point express reference may be made at the outset with respect to the construction and function of such generators.

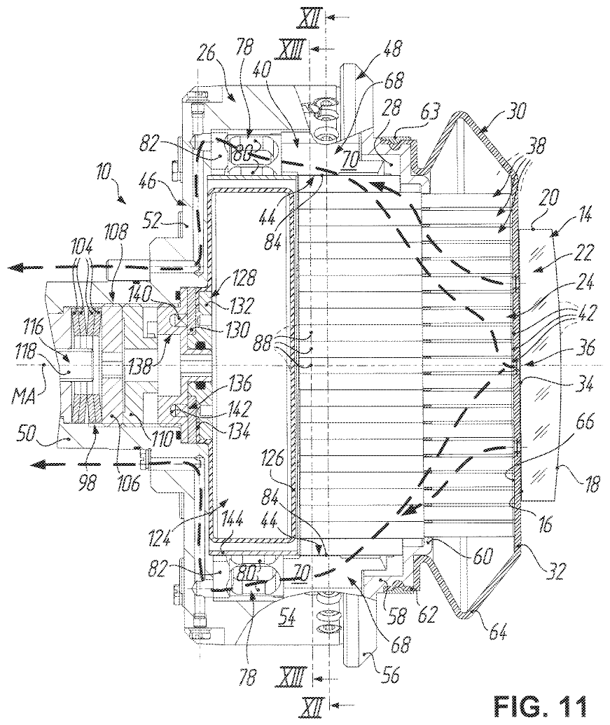

A spectacle lens 14 as an example of an optical workpiece to be processed is shown in FIG. 11. The spectacle lens 14 has two—optically effective at least at the end of the processing—workpiece surfaces 16, 18 and a workpiece edge 20 therebetween. In the different processing states, i.e. starting from the spectacle lens blank through the partly processed spectacle lens semi-finished product to the spectacle lens processed to finished state, there is always an areal workpiece. As such, the spectacle lens 14 during processing has to be reliably held (function: “holding”) and at the same time supported against undesired deformations (function: “supporting”), purposes which are served by the retainer 10 described herein. With respect to construction and function this retainer 10 is closely related to the retainer described in earlier German Patent Application DE 10 2021 005 202.1 (DE 10 2021 005 202 A1) of the same applicant, as already mentioned in the introductory portion of the description, so that in the present description there shall be discussion primarily of differences therefrom and otherwise reference is again expressly made at this point to this earlier German Patent Application.

In general, for the afore-mentioned functions of “holding” and “supporting” of a spectacle lens 14 to be processed the retainer 10 comprises a holding arrangement 22 and a support arrangement 24 in or at a multi-part housing 26 (see, in particular, FIGS. 7, 10 and 11). In the illustrated embodiment the supporting arrangement 24 has firstly a rubber-elastic membrane 30 which is mounted on the housing 26 of the retainer 10 and which together with the housing 26 bounds a chamber 28. The membrane 30 has a retaining section 32, on the outer side 34 of which the spectacle lens 14 can, according to FIG. 11, be placed over an area by one (16) of its workpiece surfaces 16, 18. In that case, a perforation 36 as a component of the holding arrangement 22 is formed in the retaining section 32 of the membrane 30, so that a vacuum—indicated in FIG. 11 by dashed arrows—applied to the chamber 28 is present by way of the perforation 36 on the outer side 34 of the retaining section 32 of the membrane 30 in order to hold the spectacle lens 14 to be processed.

In different embodiments this membrane 30 is the subject of German Patent Application 10 2023 110 129.3, filed at the same time under the title “Elastic membrane for a retainer for the processing of optical workpieces, particularly spectacle lenses, and retainer equipped therewith”, of the same applicant as already mentioned in the introductory portion of the description, to which at this point express reference is again made with respect to construction and function of the membrane 30. This membrane 30 shall therefore be described in the following only to the extent appearing necessary for an understanding of the present invention.

The support arrangement 24 further comprises a plurality of pins 38, which are accommodated in the chamber 28 and at least for the major part are separately displaceable and which can be selectively fixed against longitudinal displacement, i.e. displacement parallel to a center axis MA of the retainer 10, with respect to the housing 26 by a clamping mechanism 40. In that case, the pins 38 by their pin ends 42 serve the purpose (see FIG. 11) of firmly supporting over an area the spectacle lens 14, which is held by one of its workpiece surfaces 16, 18 by way of the holding arrangement 22 at the retainer 10, at the workpiece surface (here 16) facing the pin ends 42 in accordance with the geometry thereof.

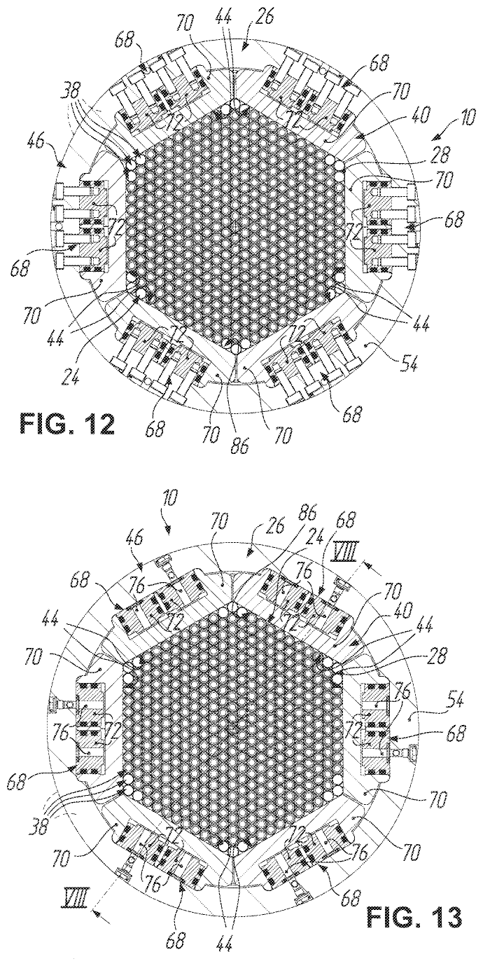

As is described in more detail in the following, the clamping mechanism 40 comprises at least one force transmission element 44—in the illustrated embodiment in fact several, namely six, force transmission elements 44 (cf. FIGS. 12 and 13)—which in accordance with an aspect important for automated operation of the retainer 10 can be moved with respect to the pins 38 by forces, which can be applied by fluid, so as to selectively clamp the pins 38 in an unactuated state of the retainer 10 or free them in an actuated state of the retainer 10.

The construction of the housing 26 of the retainer 10 can be best seen in FIG. 7. The two main components of the housing 26 are a base 46 and cover 48 mounted thereon, which are, for example, screw-connected with one another as indicated in FIG. 2. The base 46 comprises—seen from left to right in FIG. 7—a substantially hollow-cylindrical securing section 50 of smaller diameter for exchangeable securing to the workpiece spindle 12, a substantially annular base section 52 and an again substantially hollow-cylindrical chamber section 54 of greater diameter, wherein the base section 52 integrally connects the securing section 50 with the chamber section 54 of the base 46. The cover 48 is flange-mounted by a substantially annular flange section 56 on an end, which is at the right in FIG. 7, of the chamber section 54 of the base 46. A substantially hollow-cylindrical holding section 58 for the membrane 30 adjoins the flange section 56. The holding section 58 of the cover 48 ends at a substantially plate-shaped apertured limiting section 60 for the individual pins 38, wherein the holding section 58 integrally connects the flange section 56 with the limiting section 60 of the cover 48.

The membrane 30 is mounted on the holding section 58 of the cover 48 by way of an annular securing section 62 by a clamping band 63. The securing section 62 of the membrane 30 is in turn connected by a bellows section 64 of the membrane 30 with the retaining section 32 thereof, as described in detail in the afore-mentioned parallel patent application for the membrane 30. It is further apparent from, in particular, FIGS. 7 and 11 that the base 46, the cover 48 and the membrane 30 together bound the chamber 28 with the pins 38 received therein, the pin ends 42 of which can be brought into supporting contact with an inner side 66 of the membrane 30.

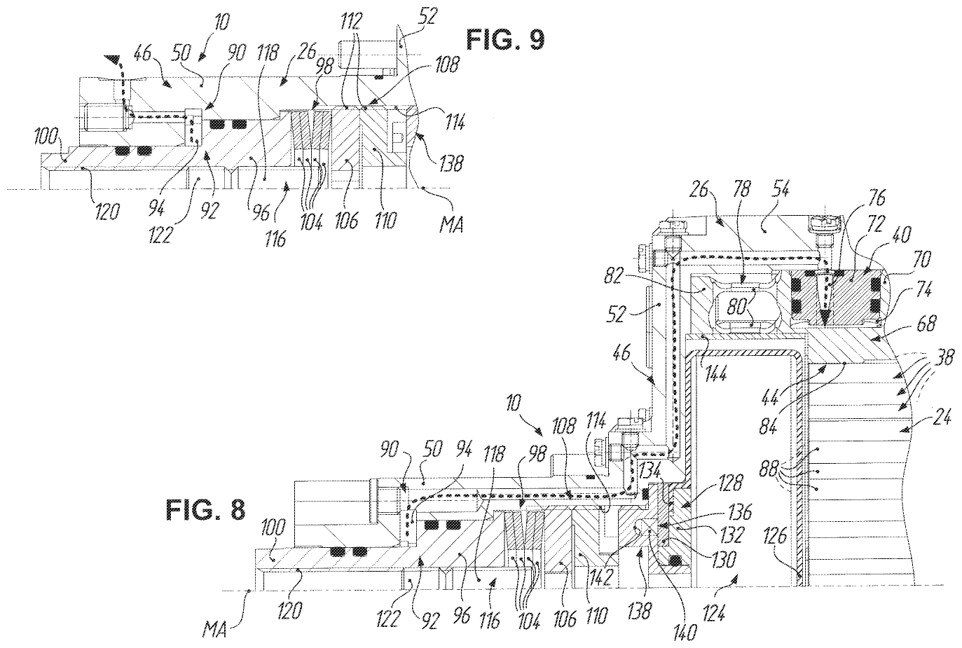

The afore-mentioned clamping mechanism 40 for the pins 38 is arranged in the housing 26, as described so far, of the retainer 10 and, in fact, in such a way that it concentrically surrounds the pins 38 with respect to the center axis MA so that a transverse force acting perpendicularly to the center axis MA can be applied to the pins 38 by the clamping mechanism 40 so as to clamp the pins 38. In that regard, a hydraulically loadable actuator 68 (see, in particular, FIGS. 8 and 12 to 15) is associated with the—in the illustrated embodiment each—force transmission element 44 of the clamping mechanism 40 so as to selectively generate a transverse movement of the respective force transmission element 44 with respect to the pins 38. In that case, the or each force transmission element 44 of the clamping mechanism 40 can be deflected by hydraulic loading of the respective actuator 68 with respect to the housing 26 of the retainer 10 against a resilient restoring force so as to clamp the pins 38, as shall be described in more detail in the following.

In this connection, firstly FIGS. 12 to 15 show that the clamping mechanism 40 comprises a plurality of force transmission elements 44—namely six in the illustrated embodiment—which surround the pins 38 in the chamber 28 in a symmetrical arrangement. A respective hydraulically loadable actuator 68 is associated with each of these force transmission elements 44, i.e. there is a total of six actuators. The different actuators 68 preferably all hydraulically communicate with one another and, in particular, by way of an appropriate hydraulic channel guidance in the housing 26 (cf. FIGS. 8, 14 and 15) so that the actuators 68 can be hydraulically loaded in common.

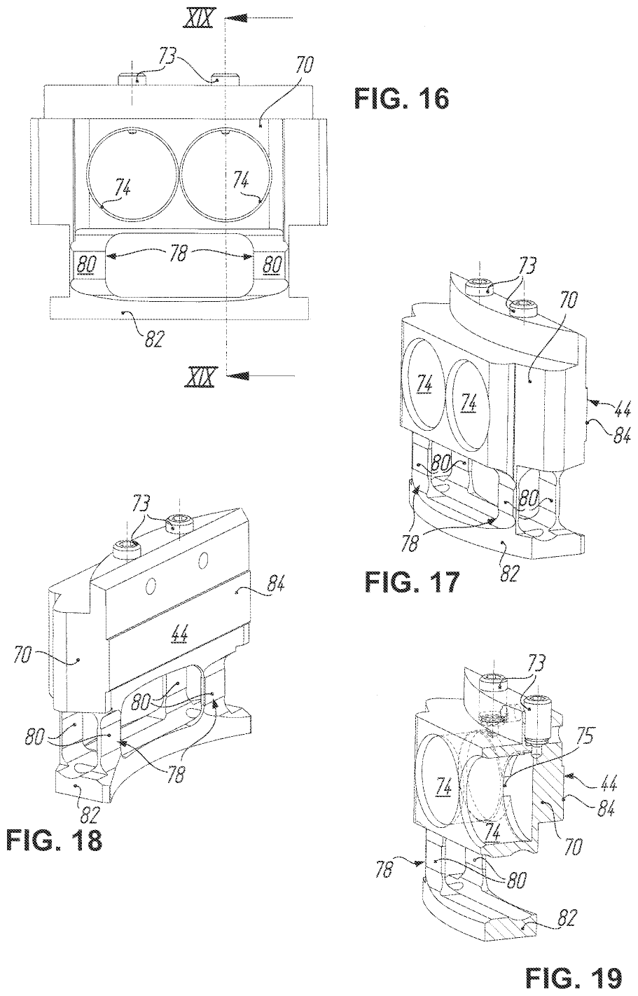

According to, in particular, FIGS. 8 and 12 to 15 the hydraulically loadable actuators in the illustrated embodiment are each a piston-cylinder arrangement 68 with a cylinder housing 70, which is shown individually in FIGS. 16 to 19, and at least one piston 72—here actually two pistons 72—arranged in the cylinder housing 70 to be effective in actuation. For that purpose the cylinder housing 70 of the piston-cylinder arrangement 68 has two cylinder chambers 74 (see, in that regard, especially FIGS. 16, 17 and 19), which can be vented by way of bleed screws 73 mounted at the top on the cylinder housing 70 and in each of which a respective piston 72 is received to be suitably sealed at its circumference, as FIGS. 12 and 13, in particular, show. The two cylinder chambers 74 of each cylinder housing 70 are in that case hydraulically connected together by way of a passage 75, as can be readily seen in FIG. 19.

It can be further inferred from FIG. 12 that each piston 72 of the piston-cylinder arrangement 68 is secured to the housing 26 of the retainer 10—in particular screw-connected with the chamber section 54 of the housing 26—so that the cylinder housing 70 of the respective piston-cylinder arrangement 68 is movable (by contrast to the piston 72) relative to the housing 26 of the retainer 10. In this connection, FIGS. 8 and 13 to 15 additionally illustrate that each piston 72 of the piston-cylinder arrangements 68 is provided with a passage 76 for hydraulic loading of the respective piston-cylinder arrangement 68.

A further special feature of the clamping mechanism 40 is that the cylinder housing 70 of each piston-cylinder arrangement 68 is mounted on the housing 26 of the retainer 10 to be resiliently deflectable and, in fact, by way of at least one solid-body joint 78—in the illustrated embodiment actually two solid-body joints 78 (see, with respect thereto, especially FIGS. 16 to 19)—which has a double arm 80 in the manner of a parallelogram guide. More precisely, each two solid-body joints 78 have a common base plate 82 which is screw-connected with the base section 52 of the housing 26 as shown by, for example, FIG. 7 and from which the said double arms 80 extend so as to carry the respective cylinder housing 70 to be resiliently deflectable.

With respect to the clamping mechanism 40 it is additionally to be said that according to, in particular, FIGS. 17 to 19 each force transmission element 44 is an integral component of a cylinder housing 70. In that case the force transmission element 44 has a planar support surface 84 for the pins 38 and projects into the chamber 28 in the mounted state of the respective cylinder housing 70 on the housing 26 (cf. FIGS. 7, 8, 11, 14 and 15).

As far as the arrangement of the pins 38 of the support arrangement 24 in the chamber 28 of the housing 26 is concerned it can be readily seen in FIGS. 12 and 13 that the pins 38 are arranged in a substantially hexagonal package in the housing 26 of the retainer 10, for which purpose six force transmission elements 44 or the contact surfaces 84 thereof bound a substantially hexagonal opening 86 through which the pins 38 extend.

As can be further inferred from the sections according to FIGS. 12 and 13, the longitudinally displaceable pins 38 of the support arrangement 24 are, in the illustrated embodiment, cylindrical pins each with an offset clamping region 88 of greatest diameter (see, especially, FIGS. 7, 8 and 11) for clamping by the clamping mechanism 40. The pins 38 in the packed arrangement thereof linearly bear against one another by their clamping regions 88. In that case, the pins 38 can have in their clamping regions 88 an outer diameter of, for example, between 1.0 millimeter and 10.0 millimeters, preferably between 2.0 millimeters and 6.0 millimeters and particularly preferably between 2.5 millimeters and 5.0 millimeters. For the dimensioning of the pins 38 account is to be taken on the one hand that the pins 38 should not be too thick, so that when forming to the usually curved workpiece surfaces 16 and 18 of the spectacle lens 14 to be retained at the retainer 10 a highest possible resolution is achieved. On the other hand, the diameter of the pins 38 downwardly is bounded primarily by production requirements or possibilities.

As far as the number of pins 38 is concerned, 469 pins with a diameter of 3 millimeters are needed for, for example, a hexagonal pin packet with a “spanner width” of 65 millimeters—in correspondence with the maximum fully supported circular shape of a spectacle lens 14 to be retained—and a corner dimension of 75 millimeters. In another variant with a hexagonal pin packet having a spanner width of 86 millimeters and a corner dimension of approximately 92 millimeters, this would be 397 pins with a diameter of 4 millimeters. The thickened clamping regions 88 of the pins 38 can have, for example, a length of approximately 30 millimeters, so that mutual guidance of the pins 38, which counteracts “canting” of the pins 38, is also provided by way of this length.

Finally, the longitudinally displaceable pins 38 of the support arrangement 24 extend by their pin ends 42 of thinner diameter through an apertured limiting plate which in the illustrated embodiment is formed by the substantially plate-shaped limiting section 60 of the cover 48 of the housing 26 and which limits longitudinal movement of the pins 38 in the housing 26 of the retainer 10.

A further special feature of the embodiment, which is shown in FIGS. 4 to 19, of the retainer 10 is how the hydraulic pressure serving for actuation of the clamping mechanism 40 of the retainer 10 is generated. In general, provision is made for that purpose for the or each hydraulically loadable actuator—i.e. the piston-cylinder arrangement or arrangements 68 in the present embodiment—associated with a force transmission element 44 to be loaded with pressure in the unactuated state of the retainer 10 by way of a pressure store 90, which in the actuated state of the retainer 10 is relieved of pressure.

In this connection, it can be inferred particularly from FIGS. 7 to 10, 14 and 15 that the pressure store 90 is integrated in the housing 26 of the retainer 10, more precisely accommodated in space-saving manner in the securing section 50 of the housing 26. In that case, the pressure store 90 also comprises a piston-cylinder arrangement 92 with a cylinder chamber 94 and a piston 96 received therein to be longitudinally displaceable. The piston 96, which is stepped in the illustrated embodiment, is biased into the also stepped cylinder chamber 94 for generation of pressure in the pressure store 90, namely spring-biased by way of a spring mechanism 98.

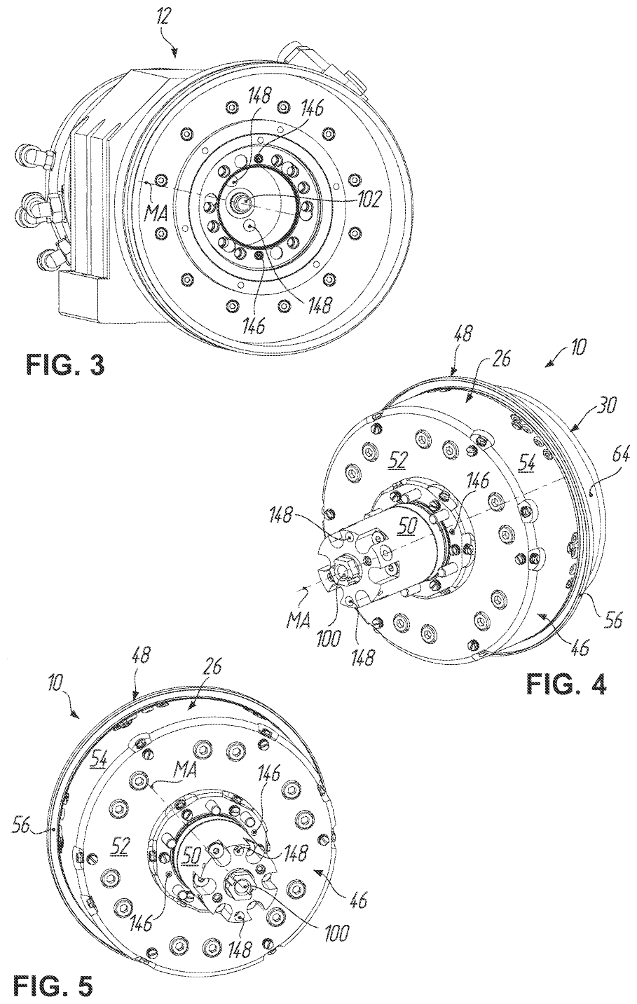

On the other hand, for pressure relief the piston 96 is mechanically displaceable in the cylinder chamber 94 against the spring bias of the spring mechanism 98. Provided at the piston 96 for that purpose is an actuating projection 100 by way of which the piston 96 can be displaced against the force of the spring mechanism 98 with, for example, the assistance of a pushrod 102 (see FIG. 3), which is on the workpiece spindle side and which is connected with the actuating projection 100 projecting out by way of the securing section 50 of the housing 26. In that case the volume of the cylinder chamber 94 increases, whereupon the cylinder housings 70 of the piston-cylinder arrangements 68 of the clamping mechanism 40 spring back—as a consequence of the resilient suspension thereof by way of the solid-body joints 78—from the pins 38 of the support arrangement 24 so that the force transmission elements 44 free the pins 38 for longitudinal displacement.

As FIGS. 7 to 10, 14 and 15, in particular, show, the spring mechanism 98 comprises plate springs 104 arranged in a row for spring-biasing of the piston 96 of the pressure store 90. The plate springs 104 bear against the piston 96 on the side remote from the cylinder chamber 94 and are supported relative to the housing 26 by a discoid counter-bearing 106 mounted in the securing section 50 of the housing 26.

In that case the arrangement is such that the spring-biasing of the piston 96 of the pressure store 90 can be set at the spring mechanism 98. In order to set the spring bias of the piston 96 of the pressure store 90 a setting mechanism 108 is provided by which a spring travel at the spring mechanism 98 can be steplessly predetermined. According to, in particular, FIG. 9 the setting mechanism 108 is formed by the counter-bearing 106 and an associated locking disc 110 for securing the counter-bearing 106, which are provided at the outer circumference with external threads 112 co-operating with an internal thread 114 at the inner circumference of the securing section 50 of the housing 26. It will be apparent to the person ordinarily skilled in the art that through turning the counter-bearing 106 and locking disc 110 in the securing section 50 of the housing 26 there is preset at the plate springs 104 a stroke by way of which the spring force, which acts on the piston 96, of the spring mechanism 98 can be set.

Moreover, the pressure store 90 has a settable abutment 116 for the piston 96 of its piston-cylinder arrangement 92, which limits mechanical displacement of the piston 96 relative to the spring mechanism 98 with respect to the housing 26 of the retainer 10. According to, in particular, FIG. 7 the abutment 116 comprises a first grub screw 118, which is screwed into a threaded bore 120 (see FIGS. 7 to 10) extending along the center axis MA through the piston 96 and which projects in the direction of the counter-bearing 106 for the plate springs 104 beyond the end of the piston 96 on the right in these figures. Through setting a suitable protrusion of the first grub screw 118 the stroke of the piston 96 in the direction of the plate springs 104 can be limited so that the projecting end of the first grub screw 118 comes into contact with the counter-bearing 106 before the plate springs 104 lie “in a block”, which is to be avoided for preserving the plate springs 104. In order to secure the first grub screw 118 in a once-set position at the piston 96 it is locked on the side remote from the counter-bearing 106 by a second grub screw 122, which is also screwed into the threaded bore 120.

With regard to the pressure store 90 integrated in the housing 26 of the retainer 10 it is additionally to be noted that FIGS. 7 to 11, 14 and 15 for simplification of the illustration show the pressure store 90 in unfilled state, i.e. without hydraulic fluid. In that case the piston 96, which is spring-biased by way of the spring mechanism 98, of the piston-cylinder arrangement 92 of the—here “dry”—pressure store 90 is in abutment at the housing 26 of the retainer 10. However, in the filled state of the pressure store 90—not illustrated in the figures—the piston 96 thereof does not bear against the housing 26, so that a force couple between the piston 96 of the pressure store 90 and the cylinder housings 70 of the piston-cylinder arrangements 68, which are associated with the force transmission elements 44, of the clamping mechanism 40 is present by way of the hydraulic fluid. The hydraulic connection between the piston-cylinder arrangement 92 of the pressure store 90 and the piston-cylinder arrangements 68 of the clamping mechanism 40, which is produced by way of appropriate channels and connecting bores in the housing 26 of the retainer 10, ultimately can be best seen in FIGS. 8, 14 and 15 and in addition is marked in FIG. 8 by a dashed arrow.

In the embodiment of the retainer 10 illustrated here—analogously to the second embodiment of the retainer according to earlier German Patent Application DE 10 2021 005 202.1 (DE 10 2021 005 202 A1), to the description of which reference may be made at this point—the longitudinally displaceable pins 38 of the support arrangement 24 are spring-biased in the direction of the inner side 66 at the retaining section 32 of the membrane 30, i.e. in a direction away from the housing 26 of the retainer 10, for which purpose a pneumatic spring element 124 is provided as shown by FIGS. 7, 8, 10, 11 and 14.

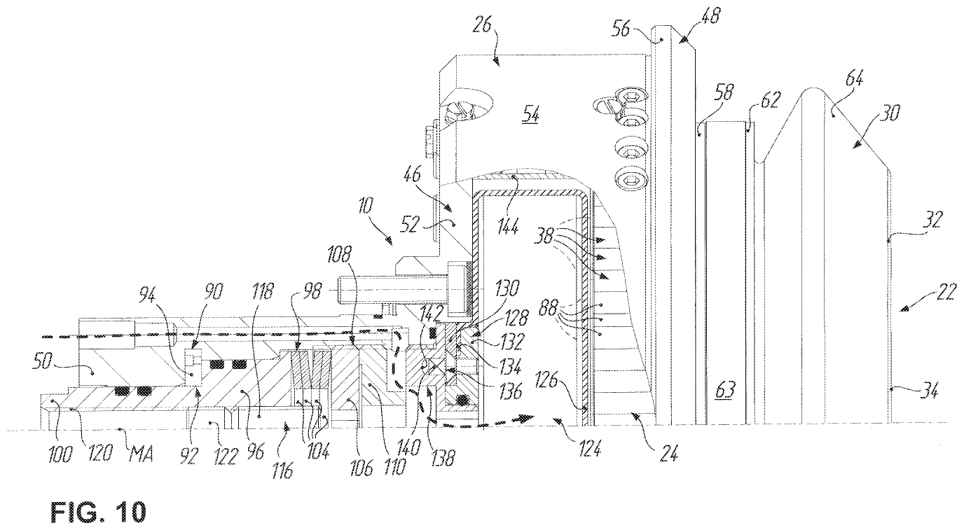

The pneumatic spring element 124 has a rubber-elastic bellows section 126, which is detachably held at a rigid securing section 128. For that purpose the securing section 128 comprises two annular parts 130, 132, which according to FIG. 10 are screw-connected together and in that case clamp an annular clamping section 134 of the bellows section 126. The securing section 128 is in addition detachably secured by way of a magnetic coupling 136 to a part, which is fixed relative to the housing, of the retainer 10, here in the form of a flange ring 138 screwed into the internal thread 114 at the securing section 50 of the housing 26. The magnetic coupling 136 in that regard comprises a permanent magnet 140, which is annular in the illustrated embodiment and is mounted in an annular groove 142 formed in the flange ring 138 (see FIGS. 8, 10 and 11) and which co-operates with the annular part 130 of the securing section 128, which can be of ferromagnetic construction, and/or the metallic screw connection so as to hold the pneumatic spring element 124 in place and position. In the event of maintenance of the retainer 10 the pneumatic spring element 124 can thereby be exchanged in simple mode and manner.

Finally, it is also to be stated that in the illustrated embodiment a slotted annular part 144 (see FIGS. 7, 8, 10, 11 and 14) is associated with the pneumatic spring element 124, which annular part protectively surrounds the rubber-elastic, substantially circularly discoid hollow bellows section 126 of the pneumatic spring element 124 at the outer circumference and radially outwardly limits deflection of the bellows section 126.

With respect to the interaction of retainer 10 and workpiece spindle 12 it remains to be noted that the housing 26 of the retainer 10 has—apart from the afore-described mechanical connection for activation of the pressure store 90 for the clamping mechanism 40 of the retainer 10 (actuating projection 100 at the retainer 10, pushrod 102 at the workpiece spindle 12)—interfaces 146, 148 for supply of the retainer 10 with vacuum and compressed air by way of the workpiece spindle 12. These are shown in FIGS. 3 to 5, wherein the interfaces for the vacuum of the holding arrangement 22 are denoted by the reference numeral 146 and the interface for the compressed air for the pneumatic spring element 124 is denoted by the reference numeral 148. The paths provided in the retainer 10 for the vacuum of the holding arrangement 22 are indicated in FIG. 11 by dashed arrows, whereas the paths provided in the retainer 10 for the compressed air for the pneumatic spring element 124 are denoted in FIG. 10 by a dashed arrow. Corresponding dashed arrows show the hydraulic paths in FIGS. 8 and 9, wherein in FIG. 8 the actuation of the clamping mechanism 40 is illustrated, while FIG. 9 shows relief of the hydraulic system.

The pneumatic supply of the workpiece spindle 12 is carried out in correspondence with the circuit diagram, which is illustrated in FIG. 1, by way of four switching valves V1, V2, V3, V4, which are connected with a common compressed air source DQ. All switching valves V1, V2, V3, V4 are biased into an operating setting by a spring and can each be switched by way of a respective solenoid. The solenoids of the switching valves are connected by way of control lines, which have dashed-line illustration, with a common control ECU for automated actuation of retainer 10 and workpiece spindle 12.

The first switching valve V1 is a 2/2-way valve which is biased into a blocking setting and which frees a connection to a first pressure connection at the workpiece spindle 12 for an air bearing of the workpiece spindle 12.

The second switching valve V2 is also a 2/2-way valve biased into a blocking setting. This switches a connection to an ejector EJ for vacuum generation, the vacuum connection of which is connected with a sub-atmospheric pressure connection of the workpiece spindle 12.

The third switching valve V3 is a 3/2-way valve biased into a discharge setting. By way of this valve, a further proportional valve PV, which is connected by way of a second pressure connection with the workpiece spindle 12, for setting of pressure at the pneumatic spring element 124 can be loaded or relieved. The proportional valve PV is also connected with the control ECU by way of a control line with dashed-line illustration.

The fourth switching valve V4 is a 5/2-way valve for pneumatic activation of a double-acting cylinder in or at the workpiece spindle 12, by which the pushrod 102 for the clamping mechanism 40 is actuable. The two outlets of the fourth switching valve V4 are respectively connected by way of a third pressure connection and a fourth pressure connection at the workpiece spindle 12 with a respective pressure chamber of the double-acting cylinder so that depending on the valve setting always one pressure chamber is loaded with pressure by way of the fourth switching valve V4 and the other pressure chamber is connected free of pressure with the environment by way of the fourth switching valve V4. The spring-biased fourth switching valve V4 is here switched in such a way that in the unactuated state of the fourth switching valve V4 the pressure chamber of the double-acting cylinder is loaded with pressure, which produces on the pushrod 102 a force in a direction away from the retainer 10.

A retainer for the processing of, in particular, spectacle lenses as workpieces comprises a housing with a holding arrangement for a workpiece to be processed and a support arrangement for that purpose, which comprises a plurality of longitudinally displaceable pins received in a chamber bounded by the housing. The pins are selectively fixable against longitudinal displacement with respect to the housing by a clamping mechanism and by their pin ends serve the purpose of firmly supporting over an area the workpiece, which is held by one of its workpiece surfaces at the retainer by way of the holding arrangement, at the workpiece surface facing the pin ends in accordance with the geometry thereof. The clamping mechanism has at least one force transmission element, which is movable with respect to the pins by forces, which can be applied by fluid, so as to selectively clamp the pins in an unactuated state of the retainer or free them in an actuated state of the retainer.

Other variations and modifications are possible without departing from the scope and spirit of the present invention as defined by the appended claims.

1. A retainer (10) for the processing of optical workpieces (14), which each have two workpiece surfaces (16, 18) and a workpiece edge (20) therebetween, comprising a housing (26) with a holding arrangement (22) for a workpiece (14) to be processed as well as a support arrangement (24) therefor, which comprises a plurality of pins (38) accommodated in a chamber (28) bounded by the housing (26), which for at least the major part are separately longitudinally displaceable and which are selectively fixable by a clamping mechanism (40) against longitudinal displacement with respect to the housing (26) and with their pin ends (42) firmly supporting the workpiece (14), which is held by one of its workpiece surfaces (16, 18) at the retainer (10) by way of the holding arrangement (22), over an area at the workpiece surface (16) facing the pin ends (42) in accordance with the geometry of the surface, wherein the clamping mechanism (40) has at least one force transmission element (44) which is movable with respect to the pins (38) by forces able to be applied by fluid so as to selectively clamp the pins (38) in an unactuated state of the retainer (10) or free them in an actuated state of the retainer (10).

2. A retainer (10) according to claim 1, wherein a hydraulically loadable actuator (68) is associated with the at least one force transmission element (44) so as to selectively generate a transverse movement of the force transmission element (44) with respect to the pins (38).

3. A retainer (10) according to claim 2, wherein the at least one force transmission element (44) is deflectable by hydraulic loading of the actuator (68) with respect to the housing (26) of the retainer (10) against a resilient restoring force so as to clamp the pins (38).

4. A retainer (10) according to claim 3, wherein the hydraulically loadable actuator is a piston-cylinder arrangement (68) with a cylinder housing (70) and at least one piston (72).

5. A retainer (10) according to claim 4,
wherein the at least one piston (72) of the piston-cylinder arrangement (68) is secured to the housing (26) of the retainer (10) so that the cylinder housing (70) of the piston-cylinder arrangement (68) is movable relative to the housing (26) of the retainer (10), and/or
wherein the at least one piston (72) of the piston-cylinder arrangement (68) is provided with a passage (76) for hydraulic loading of the piston-cylinder arrangement (68) and/or
wherein the cylinder housing (70) of the piston-cylinder arrangement (68) comprises two cylinder chambers (74) in each of which a respective piston (72) is received with sealing at the circumference and/or
wherein the cylinder housing (70) of the piston-cylinder arrangement (68) is mounted on the housing (26) of the retainer (10) by way of at least one solid-body joint (78), which comprises a double arm (80) in the form of a parallelogram guide, to be resiliently deflectable.

6. A retainer (10) according to claim 5,
wherein the force transmission element (44) is an integral component of the cylinder housing (70) and/or
wherein the force transmission element (44) has a planar contact surface (84) for the pins (38) and projects from the cylinder housing (70) into the chamber (28).

7. A retainer (10) according to claim 6, wherein the actuator (68) in the unactuated state of the retainer (10) is loaded with pressure by way of a pressure store (90), which in the actuated state of the retainer (10) is relieved of pressure.

8. A retainer (10) according to claim 7,
wherein the pressure store (90) is integrated in the housing (26) of the retainer (10) and/or
wherein the pressure store (90) comprises a piston-cylinder arrangement (92) with a cylinder chamber (94) and a piston (96), which is spring-biased into the cylinder chamber (94) by way of a spring mechanism (98) for generating pressure and which is mechanically displaceable in the cylinder chamber (94) against the spring bias for relief of pressure.

9. A retainer (10) according to claim 8,
wherein the spring mechanism (98) comprises plate springs (104), which are arranged in a row, for spring-biasing of the piston (96) of the pressure store (90) and/or
wherein the spring bias of the piston (96) of the pressure store (90) is settable at the spring mechanism (98) and/or
wherein for setting of the spring bias of the piston (96) the pressure store (90) comprises a setting mechanism (108) by way of which a spring travel at the spring mechanism (98) is steplessly predeterminable and/or
wherein the pressure store (90) has a settable abutment (116) for the piston (96) of its piston-cylinder arrangement (92), which abutment limits mechanical displacement of the piston (96) against the spring mechanism (98) with respect to the housing (26) of the retainer (10).

10. A retainer (10) according to claim 9,
wherein the clamping mechanism (40) comprises a plurality of force transmission elements (44) which surround the pins (38) in the chamber (28) in symmetrical arrangement and with each of which a respective hydraulically loadable actuator (68) is associated and/or
wherein the clamping mechanism (40) comprises a plurality of actuators (68) which hydraulically communicate with one another so that the actuators (68) are hydraulically loadable in common.

11. A retainer (10) according to claim 10, wherein the support arrangement (24) comprises a rubber-elastic membrane (30), which is mounted on the housing (26) of the retainer (10) and together with the housing (26) bounds the chamber (28) and which has a retaining section (32), on the outer side (34) of which the workpiece (14) can be laid over an area by one of its workpiece surfaces (16, 18), wherein a perforation (36) as a component of the holding arrangement (22) is formed in the retaining section (32) of the rubber-elastic membrane (30) so that a vacuum applied to the chamber (28) is present by way of the perforation (36) on the outer side (34) of the retaining section (32) of the rubber-elastic membrane (30) for holding a workpiece (14) to be processed.

12. A retainer (10) according to claim 11,
wherein the longitudinally displaceable pins (38) of the support arrangement (24) are spring-biased in a direction away from the housing (26) of the retainer (10) and/or
wherein the longitudinally displaceable pins (38) of the support arrangement (24) are spring-biased with the help of at least one pneumatic spring element (124) in a direction away from the housing (26) of the retainer (10).

13. A retainer (10) according to claim 12,
wherein the pneumatic spring element (124) has a rubber-elastic bellows section (126) that is held preferably detachably at a rigid securing section (128) which is detachably secured by way of a magnetic coupling (136) to a part (138), which is fixed relative to the housing, of the retainer (10) and/or
wherein associated with the pneumatic spring element (124) is an annular part (144) which protectively surrounds a rubber-elastic, substantially circularly discoid hollow bellows section (126) of the pneumatic spring element (124) at the outer circumference and radially outwardly limits deflection of the bellows section (126).

14. A retainer (10) according to claim 13,
wherein the pins (38) of the support arrangement (24) are arranged in the housing (26) of the retainer (10) in a substantially hexagonal package, for which purpose six force transmission elements (44) bound a substantially hexagonal opening (86) through which the pins (38) extend and/or
wherein the longitudinally displaceable pins (38) of the support arrangement (24) are cylindrical pins each with an offset clamping region (88) of greatest diameter for clamping by the clamping mechanism (40), wherein the pins (38) bear linearly against one another by the clamping regions (88) thereof and/or the clamping regions (88) of the pins (38) have an outer diameter between 1.0 millimeter and 10.0 millimeters, preferably between 2.0 millimeters and 6.0 millimeters and particularly preferably between 2.5 millimeters and 5.0 millimeters, and/or
wherein the longitudinally displaceable pins (38) of the support arrangement (24) extend by their pin ends (42) through at least one apertured limiting plate (60) which limits longitudinal movement of the pins (38) in the housing (26) of the retainer (10).

15. A retainer (10) according to claim 14,
wherein the housing (26) of the retainer (10) has a securing section (50) for exchangeable securing to a workpiece spindle (12) and/or
wherein the housing (26) of the retainer (10) has interfaces (146, 148) for supply of the retainer (10) with vacuum and compressed air by way of a workpiece spindle (12).

16. A retainer (10) according to claim 2, wherein the hydraulically loadable actuator is a piston-cylinder arrangement (68) with a cylinder housing (70) and at least one piston (72).

17. A retainer (10) according to claim 16,
wherein the at least one piston (72) of the piston-cylinder arrangement (68) is secured to the housing (26) of the retainer (10) so that the cylinder housing (70) of the piston-cylinder arrangement (68) is movable relative to the housing (26) of the retainer (10), and/or
wherein the at least one piston (72) of the piston-cylinder arrangement (68) is provided with a passage (76) for hydraulic loading of the piston-cylinder arrangement (68) and/or
wherein the cylinder housing (70) of the piston-cylinder arrangement (68) comprises two cylinder chambers (74) in each of which a respective piston (72) is received with sealing at the circumference and/or
wherein the cylinder housing (70) of the piston-cylinder arrangement (68) is mounted on the housing (26) of the retainer (10) by way of at least one solid-body joint (78), which comprises a double arm (80) in the form of a parallelogram guide, to be resiliently deflectable.

18. A retainer (10) according to claim 4,
wherein the force transmission element (44) is an integral component of the cylinder housing (70) and/or
wherein the force transmission element (44) has a planar contact surface (84) for the pins (38) and projects from the cylinder housing (70) into the chamber (28).

19. A retainer (10) according to claim 2, wherein the actuator (68) in the unactuated state of the retainer (10) is loaded with pressure by way of a pressure store (90), which in the actuated state of the retainer (10) is relieved of pressure.

20. A retainer (10) according to claim 19,
wherein the pressure store (90) is integrated in the housing (26) of the retainer (10) and/or
wherein the pressure store (90) comprises a piston-cylinder arrangement (92) with a cylinder chamber (94) and a piston (96), which is spring-biased into the cylinder chamber (94) by way of a spring mechanism (98) for generating pressure and which is mechanically displaceable in the cylinder chamber (94) against the spring bias for relief of pressure.

21. A retainer (10) according to claim 20,
wherein the spring mechanism (98) comprises plate springs (104), which are arranged in a row, for spring-biasing of the piston (96) of the pressure store (90) and/or
wherein the spring bias of the piston (96) of the pressure store (90) is settable at the spring mechanism (98) and/or
wherein for setting of the spring bias of the piston (96) the pressure store (90) comprises a setting mechanism (108) by way of which a spring travel at the spring mechanism (98) is steplessly predeterminable and/or
wherein the pressure store (90) has a settable abutment (116) for the piston (96) of its piston-cylinder arrangement (92), which abutment limits mechanical displacement of the piston (96) against the spring mechanism (98) with respect to the housing (26) of the retainer (10).

22. A retainer (10) according to claim 2,
wherein the clamping mechanism (40) comprises a plurality of force transmission elements (44) which surround the pins (38) in the chamber (28) in symmetrical arrangement and with each of which a respective hydraulically loadable actuator (68) is associated and/or
wherein the clamping mechanism (40) comprises a plurality of actuators (68) which hydraulically communicate with one another so that the actuators (68) are hydraulically loadable in common.

23. A retainer (10) according to claim 1, wherein the support arrangement (24) comprises a rubber-elastic membrane (30), which is mounted on the housing (26) of the retainer (10) and together with the housing (26) bounds the chamber (28) and which has a retaining section (32), on the outer side (34) of which the workpiece (14) can be laid over an area by one of its workpiece surfaces (16, 18), wherein a perforation (36) as a component of the holding arrangement (22) is formed in the retaining section (32) of the rubber-elastic membrane (30) so that a vacuum applied to the chamber (28) is present by way of the perforation (36) on the outer side (34) of the retaining section (32) of the rubber-elastic membrane (30) for holding a workpiece (14) to be processed.

24. A retainer (10) according to claim 1,
wherein the longitudinally displaceable pins (38) of the support arrangement (24) are spring-biased in a direction away from the housing (26) of the retainer (10) and/or
wherein the longitudinally displaceable pins (38) of the support arrangement (24) are spring-biased with the help of at least one pneumatic spring element (124) in a direction away from the housing (26) of the retainer (10).

25. A retainer (10) according to claim 24,
wherein the pneumatic spring element (124) has a rubber-elastic bellows section (126) that is held preferably detachably at a rigid securing section (128) which is detachably secured by way of a magnetic coupling (136) to a part (138), which is fixed relative to the housing, of the retainer (10) and/or
wherein associated with the pneumatic spring element (124) is an annular part (144) which protectively surrounds a rubber-elastic, substantially circularly discoid hollow bellows section (126) of the pneumatic spring element (124) at the outer circumference and radially outwardly limits deflection of the bellows section (126).

26. A retainer (10) according to claim 1,
wherein the pins (38) of the support arrangement (24) are arranged in the housing (26) of the retainer (10) in a substantially hexagonal package, for which purpose six force transmission elements (44) bound a substantially hexagonal opening (86) through which the pins (38) extend and/or
wherein the longitudinally displaceable pins (38) of the support arrangement (24) are cylindrical pins each with an offset clamping region (88) of greatest diameter for clamping by the clamping mechanism (40), wherein the pins (38) bear linearly against one another by the clamping regions (88) thereof and/or the clamping regions (88) of the pins (38) have an outer diameter between 1.0 millimeter and 10.0 millimeters, preferably between 2.0 millimeters and 6.0 millimeters and particularly preferably between 2.5 millimeters and 5.0 millimeters, and/or
wherein the longitudinally displaceable pins (38) of the support arrangement (24) extend by their pin ends (42) through at least one apertured limiting plate (60) which limits longitudinal movement of the pins (38) in the housing (26) of the retainer (10).

27. A retainer (10) according to claim 1,
wherein the housing (26) of the retainer (10) has a securing section (50) for exchangeable securing to a workpiece spindle (12) and/or
wherein the housing (26) of the retainer (10) has interfaces (146, 148) for supply of the retainer (10) with vacuum and compressed air by way of a workpiece spindle (12).
